(19) United States
(12) Patent Application Publication
(10) Pub. No.: US 2017/0159551 A1
(43) Pub. Date: Jun. 8, 2017

(54) TURBOCHARGER STRUCTURE FOR VEHICLE

(71) Applicants: HYUNDAI MOTOR COMPANY, Seoul (KR); KIA MOTORS CORPORATION, Seoul (KR)

(72) Inventor: Dong Ho CHU, Ansan-si, Gyeonggi-do (KR)

(21) Appl. No.: 15/221,305

(22) Filed: Jul. 27, 2016

(30) Foreign Application Priority Data
Dec. 8, 2015 (KR) 10-2015-0174493

(51) Int. Cl. F02B 37/02

(52) U.S. Cl. CPC F02B 37/025

(57) ABSTRACT

A turbocharger structure for a vehicle includes a turbine turned by exhaust gas, a first scroll communicating with an exhaust port of an engine block so as to allow the exhaust gas to flow therein, the first scroll surrounding the turbine by extending along a circumferential direction of the turbine and being provided with an opening at an end thereof for discharging exhaust gas to the turbine, and a second scroll communicating with an exhaust port of the engine block so as to allow exhaust gas to flow therein, the second scroll surrounding the turbine, along with the first scroll by extending along the circumferential direction of the turbine, and being provided with an opening at an end thereof for discharging exhaust gas to the turbine, wherein the ends of the first scroll and the second scroll having the respective openings are disposed at different locations on a circumference of the turbine.

### CROSS REFERENCE TO RELATED APPLICATION

The present application claims the benefit of priority to Korean Patent Application No. 10-2015-0174493, filed Dec. 8, 2015 with the Korean Intellectual Property Office, the entire contents of which is incorporated herein for all purposes by reference.

### TECHNICAL FIELD

The present disclosure generally relates to a turbocharger for a vehicle used to improve combustion efficiency, and more particularly, to a turbocharger structure for a vehicle that is configured to improve performance of a turbocharger and an engine by reducing exhaust interference.

### BACKGROUND

Generally, a vehicle may be provided with a turbocharger, which is a device for improving engine power. The turbocharger improves volumetric efficiency of intake air that flows into a combustion chamber of an engine by compressing the intake air using pressure of exhaust gas that is discharged into an exhaust system of the engine. Thus, the turbocharger has been applied to many diesel engines, and recently, to gasoline engines.

In order to improve turbocharger performance at low-medium speeds and at high speeds, a twin scroll type turbocharger may be used. The twin scroll type turbocharger has two passages connected from an exhaust manifold to a turbocharger, thereby improving performance of the turbocharger and the engine.

However, even if the twin scroll type turbocharger is provided with two exhaust gas passages in consideration of a firing order of combustion chambers, exhaust gas flow distances from respective exhaust ports to ends of respective scrolls may be different from each other, thereby increasing exhaust interference. Thus, a difference in exhaust performance between combustion chambers may occur, which may affect combustion stability.

In the related art, when the difference in exhaust performance between combustion chambers becomes larger, the engine is controlled in consideration of maximum difference in exhaust performance between combustion chambers so as to ensure desired combustion stability. In such a case, efficiency of the engine is reduced, thereby adversely affecting engine performance and gas mileage.

The foregoing is intended merely to aid in the understanding of the background of the present disclosure, and is not intended to mean that the present disclosure falls within the purview of the related art that is already known to those skilled in the art.

### SUMMARY

Accordingly, the present disclosure has been made keeping in mind the above problems occurring in the related art, and the present disclosure is intended to propose a twin scroll type turbocharger configured such that respective scrolls have equal exhaust gas flow distances so as to reduce exhaust interference and to minimize a difference in exhaust performance between combustion chambers, ensuring desired combustion stability, thereby being capable of improving performance of engine and gas mileage.

In order to achieve the above object, according to one aspect of the present disclosure, there is provided a turbocharger structure for a vehicle, the turbocharger structure may include: a turbine turned by exhaust gas; a first scroll communicating with an exhaust port of an engine block so as to allow exhaust gas to flow therein, the first scroll surrounding the turbine by extending along a circumferential direction of the turbine, and being provided with an opening at an end thereof for discharging exhaust gas to the turbine; and a second scroll communicating with an exhaust port of the engine block so as to allow exhaust gas to flow therein, the second scroll surrounding the turbine, along with the first scroll by extending along the circumferential direction of the turbine, and being provided with an opening at an end thereof for discharging exhaust gas to the turbine; wherein the ends of the first scroll and the second scroll having the respective openings are disposed at different locations on a circumference of the turbine.

The first scroll and the second scroll may communicate with different exhaust ports, respectively, and may alternately receive exhaust gas from the respective exhaust ports.

An exhaust gas flow distance from the exhaust port communicating with the first scroll to the opening provided at the end of the first scroll may be equal to an exhaust gas flow distance from the exhaust port communicating with the second scroll to the opening provided at the end of the second scroll.

The first scroll may communicate with the exhaust port by being connected to a first runner, and the second scroll may communicate with the exhaust port by being connected to a second runner, wherein the first runner may be longer than the second runner, and the first scroll may be shorter than the second scroll.

Portions where the first scroll and the second scroll surround the turbine may be configured such that a cross-sectional area of exhaust gas flow is reduced as each scroll approaches an associated opening.

According to the above-mentioned turbocharger structure for a vehicle, the twin scroll type turbocharger of the present disclosure may be configured such that respective scrolls have equal exhaust gas flow distances so as to reduce exhaust interference and to minimize a difference in exhaust performance between combustion chambers thus ensuring desired combustion stability, thereby being capable of improving performance of engine and gas mileage.

In particular, the ends of the first scroll and the second scroll, each having openings, may be disposed at different locations on the circumference of the turbine, and thereby may be capable of making the gas flow distances between scrolls equal to each other, unlike in the conventional art where the gas flow distances between scrolls are different from each other. Thus, it is possible to minimize a difference in exhaust interference between cylinders.

Further, the first scroll and the second scroll may be connected to different exhaust ports, wherein exhaust ports that are connected to the same scroll may not belong to successive cylinders according to a firing order of combustion chambers, whereby it is possible to minimize exhaust interference between combustion chambers that are connected to one of the scrolls.

Meanwhile, each end of the first scroll and the second scroll is configured such that a cross-sectional area of exhaust gas flow is reduced as each scroll approaches the associated opening so as to improve flow velocity of exhaust gas that is needed to turn the turbine. Thereby, it is possible to improve efficiency of the turbocharger.

### BRIEF DESCRIPTION OF THE DRAWINGS

The above and other objects, features and other advantages of the present disclosure will be more clearly understood from the following detailed description when taken in conjunction with the accompanying drawings, in which:

FIG. 1 is a view illustrating a turbocharger structure for a vehicle according to an embodiment of the present disclosure;

FIG. 2 is a view illustrating a state where scrolls are formed in a turbocharger structure for a vehicle according to an embodiment of the present disclosure; and

FIG. 3 is a view illustrating ends of scrolls in a turbocharger structure for a vehicle according to an embodiment of the present disclosure.

### DETAILED DESCRIPTION

Hereinbelow, an exemplary embodiment of the present disclosure will be described in detail with reference to the accompanying drawings.

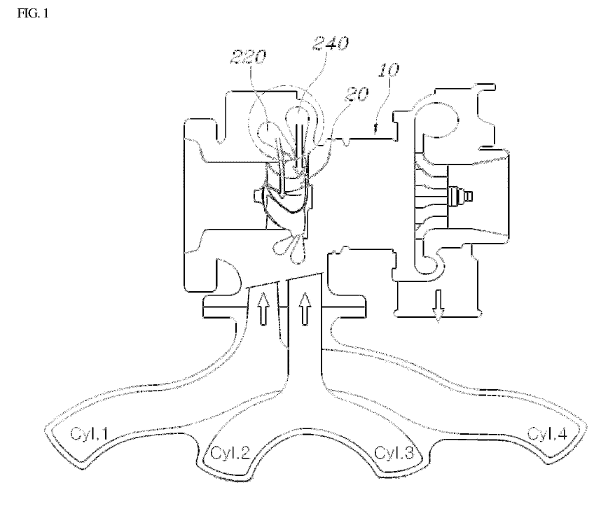

As shown in FIGS. 1 to 3, a turbocharger structure for a vehicle 100 according to the present disclosure may include a turbine 20 turned by exhaust gas, a first scroll 220 communicating with an exhaust port 40 of an engine block 30 so as to allow exhaust gasses to flow therein, the first scroll 220 may be configured to surround the turbine 20 by extending along a circumferential direction of the turbine 20, and may be provided with an opening 225 at an end thereof for discharging exhaust gas to the turbine 20, and a second scroll 240 communicating with an exhaust port 40 of the engine block 30 so as to allow exhaust gasses to flow therein, the second scroll 240 may be configured to surround the turbine 20, along with the first scroll 220, by extending along the circumferential direction of the turbine 20, and may be provided with an opening 245 at an end thereof for discharging exhaust gasses to the turbine 20, wherein the ends of the first scroll 220 and the second scroll 240 having the respective openings 225 and 245 may be disposed at different locations on a circumference of the turbine 20.

The turbine 20 may be configured to be turned by exhaust gas. The turbine 20 according to the present disclosure may be provided on a first side of a turbocharger 10, and the turbine 20 may be connected to a compressor that is provided on a second side of the turbocharger 10 so as to be turned with the compressor. The exhaust gas that turns the turbine 20 may flow into a side of the turbine 20 by the scroll, the turbine 20 may thus be turned by an effect (pressure and kinetic energy) of the exhaust gas flow, and the compressor connected to the turbine 20 may be turned along with the turbine 20, thereby compressing intake air.

FIG. 1 is a view illustrating a turbocharger 10 and scrolls that serve as exhaust gas passages, and shows the turbine 20 provided within the turbocharger 10.

Meanwhile, the first scroll 220 and the second scroll 240 may communicate with the exhaust ports 40 of the engine block 30 via a first runner 222 and a second runner 242 so as to allow exhaust gas to flow therein, may be configured to surround the turbine 20 by extending along a circumferential direction of the turbine 20, and may be provided with openings 225, 245 at respective ends of the scrolls for discharging exhaust gas to the turbine 20.

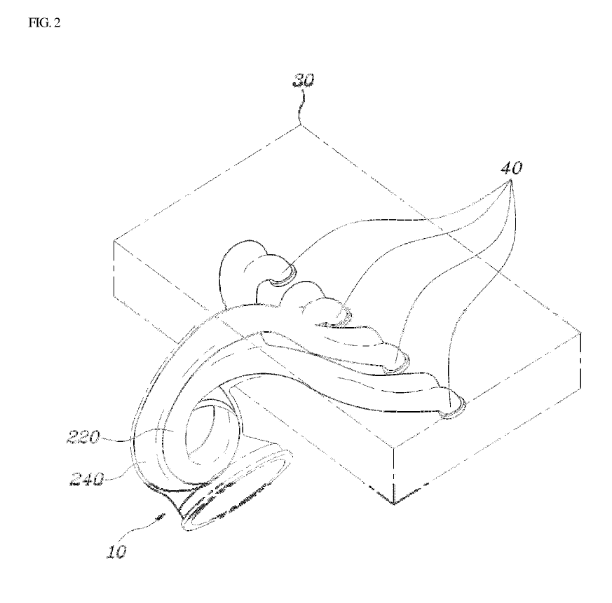

The first and the second scrolls 220, 240 may communicate with the exhaust ports 40 provided in respective combustion chambers of the engine block 30. Each of the ends of the scrolls, that may include openings 225, 245, may be disposed on a side of the turbine 20. The first scroll 220 and the second scroll 240 respectively may communicate with a plurality of the exhaust ports 40. FIG. 2 is a view illustrating the first and the second runners 222, 242 configured to communicate with a plurality of the exhaust ports 40, and the first and the second scrolls 220, 240 respectively communicating with the first and the second runners 222, 242.

The exhaust gas discharged from the combustion chamber may flow in the first scroll 220 or the second scroll 240 via the exhaust port 40 and the first and the second runners 222, 242. The first and the second scrolls 220, 240 may serve as passages that allow exhaust gas to flow toward the turbine 20, wherein the first and the second scrolls 220, 240 may be configured to surround the turbine 20.

Further, the first and the second scrolls 220, 240 may be configured to be in close contact with each other, and may be in parallel with each other so as to each have an equal distance as that of each other from each respective scroll 220, 240 to a central axis of the turbine 20 in a radial direction. FIG. 1 is a schematic view illustrating the first and the second scrolls 220, 240, which may be provided on the side of the turbine 20, being configured to be in parallel with each other.

The exhaust gas discharged through the openings 225 and 245, which may be formed at the ends of the first and the second scrolls 220, 240, flows in a circumferential direction of the turbine 20 because the first and the second scrolls 220, 240 may be configured to surround the turbine 20, and the exhaust gas may be discharged to the side of the turbine 20. Thereby, exhaust gas flow that is supplied to the side of the turbine 20 may be discharged toward the side of the turbine 20 while having an optimum flow direction to turn the turbine 20.

Meanwhile, the ends of the first scroll 220 and the second scroll 240, which may be formed with the openings 225, 245, may be disposed at different locations on the circumference of the turbine 20.

The ‘circumference of the turbine 20’ is a circumference of the central axis of the turbine 20 and may be located around of blades of the turbine 20.

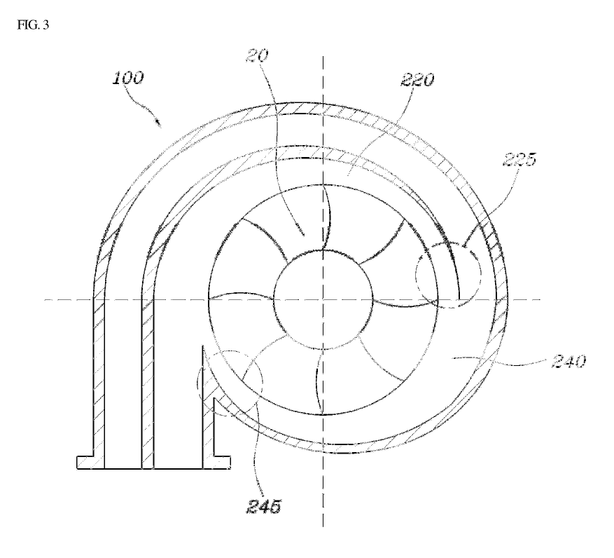

FIG. 3 is a sectional view of the side of the turbine 20 provided with the first and the second scrolls 220, 240, showing a state where the openings 225, 245 of the first scroll 220 and the second scroll 240 are disposed at different locations on the circumference of the turbine 20.

As described above, the first and the second scrolls 220, 240 may serve as passages that allow exhaust gas, which is discharged from the combustion chamber and flows in through the exhaust port 40, to flow toward the side of the turbine 20. Here, each exhaust port 40 that communicates with one of the first and the second scrolls 220, 240 may be different from the other, whereby each may have a different distance to the turbine 20 (a length of the first runner may be different from a length of the second runner). In addition, the first and the second scrolls 220, 240 may be configured to be separate from each other so that the first and the second scrolls 220, 240 cannot be provided on a same route. Considering the difference in distance and layout, which are described above, even though the first and the second scrolls 220, 240 may be configured to be in close contact with each other, and to extend toward the side of the turbine 20, thereby having the openings 225, 245 that are disposed at a same location on a circumference of the turbine 20, a difference in exhaust gas flow distance between the first and the second scrolls 220, 240 may occur.

When the difference in exhaust gas flow distance between the first and the second scrolls occurs, exhaust interference may occur, meaning exhaust gas that flows through one of the scrolls interferes with flow of exhaust gas that flows through another scroll.

When exhaust interference occurs, an exhaust stroke, which is needed to discharge exhaust gas to outside after firing in the combustion chamber, may be overloaded. When each combustion chamber has a different load on the exhaust stroke, a difference in exhaust performance between cylinders may occur, thereby adversely affecting engine performance and gas mileage.

Therefore, the ends of the first scroll 220 and the second scroll 240 may be disposed at different locations in consideration of exhaust gas flow distance from the exhaust ports 40 to associated openings 225, 245 of the first and the second scrolls 220, 240. In other words, the openings 225, 245 of the first scroll 220 and the second scroll 240 may be disposed at locations that make each length of the exhaust gas passages respectively communicating with the first scroll 220 and the second scroll 240 perfectly or substantially equal to each other, thereby minimizing exhaust interference, which may be caused by a difference in exhaust gas flow distances, and minimizing a difference in performance between cylinders. Thus, it is possible to improve engine performance and gas mileage.

When each length of the exhaust gas passages has a tolerance with each other, the tolerance can be a few centimeters.

In other words, an exhaust gas flow distance from the exhaust port 40 communicating with the first scroll 220 to the opening 225 provided at the end of the first scroll 220 may be perfectly or substantially equal to an exhaust gas flow distance from the exhaust port 40 communicating with the second scroll 240 to the opening 245 provided at the end of the second scroll 240.

As shown in FIGS. 1 and 2, the turbocharger structure for a vehicle 100 according to an embodiment of the present disclosure may be configured such that the first scroll 220 and the second scroll 240 each communicate with a different exhaust port 40, and each receive exhaust gas from the different exhaust port 40 alternately.

To be more specific, the first scroll 220 and the second scroll 240 may communicate with different exhaust ports 40 of a plurality of the exhaust ports 40 that are provided in the engine block 30. Each power stroke occurs in a plurality of the combustion chambers that are provided in the engine block 30, according to a firing order of the combustion chambers. A plurality of the exhaust ports 40 that are connected to the same scroll may not belong to combustion chambers that fire successively according to the firing order.

In other words, exhaust gas discharged from the combustion chambers may not flow through one scroll, but may flow through the first scroll 220 and the second scroll 240, alternately according to the firing order of the combustion chambers.

Thereby, it is possible to maintain balance between exhaust gases flowing through a plurality of the exhaust gas passages, and to minimize exhaust interference. Thus, the turbocharger structure for a vehicle 100 according to an embodiment of the present disclosure is advantageous in that engine performance and gas mileage can be improved. FIGS. 1 and 2 are views showing the structure of scrolls communicating with different exhaust ports 40.

As shown in FIG. 2, a turbocharger structure for a vehicle 100 according to an embodiment of the present disclosure may be configured such that the first scroll 220 communicates with the exhaust port 40 by being connected to the first runner 222, and the second scroll 240 communicates with the exhaust port 40 by being connected to the second runner 242, wherein the first runner 222 is longer than the second runner 242, and the first scroll 220 is shorter than the second scroll 240.

To be more specific, according to an embodiment of the present disclosure, the first runner 222 and the second runner 242 may communicate with different exhaust ports 40. Further, the first runner 222 may communicate with the first scroll and the second runner 242 may communicate with the second scroll 240. FIG. 2 shows a structural relation between the first and second runners 222, 242 and the first and second scrolls 220, 240.

The first runner 222 and the first scroll 242 may be integrally formed with each other, or may be coupled to each other by being individually provided. Consequently, an exhaust gas flow distance from the exhaust port 40 to the opening 225 of the first scroll 220 may be equal to a total length of the first runner 222 and the first scroll 220. A relation between the second runner 242 and the second scroll 240 may be the same as a relation between the first runner 222 and the first scroll 220.

Meanwhile, the first runner 222 and the second runner 242 may communicate with different exhaust ports 40, respectively, whereby a length of the first runner 222 may be different from a length of the second runner 242.

According to an embodiment of the present disclosure, the first runner 222 may be longer than the second runner 242, and the first scroll 220 may be shorter than the second scroll 240 such that the total length of the first runner 222 and the first scroll 220 may be equal to a total length of the second runner 242 and the second scroll 240.

In other words, even when a length of the first runner 222 is different from a length of the second runner 242, the exhaust gas flow distance from the exhaust port 40 communicating with the first scroll 220 to the opening 225 of the first scroll 220 may be equal to an exhaust gas flow distance from the exhaust port 40 communicating with the second scroll 240 to the opening 245 of the second scroll 240.

According to an embodiment of the present disclosure, the first runner 222 and the second runner 242 may be defined by the length therebetween. When two runners are provided, the longer runner of the two may be the first runner 222, and the other runner may be the second runner 242.

As shown in FIG. 3, a turbocharger structure for a vehicle 100 according to an embodiment of the present disclosure may be provided with portions, where the first scroll 220 and the second scroll 240 surround the turbine 20 and are configured such that a cross-sectional area of exhaust gas flow is reduced when coming closer to an associated opening 225 or 245.

To be more specific, as the turbine 20 is turned by exhaust gas flow, the faster the flow a velocity of an exhaust gas, the higher the maximum rotation speed of the turbine 20 may be. Thus, each of the first scroll 220 and the second scroll 240 may be configured such that a cross-sectional area of exhaust gas flow is reduced as each respective scroll 220, 240 approaches an associated opening, thereby increasing a velocity of the exhaust gas that is discharged from the openings 225, 245.

FIG. 3 is a schematic view illustrating the first scroll 220 and the second scroll 240, and further illustrating a structure where a cross-sectional area of exhaust gas flow of each scroll is reduced as each comes closer to an associated opening 225 or 245.

Although embodiments of the present disclosure have been described for illustrative purposes, those skilled in the art will appreciate that various modifications, additions and substitutions are possible, without departing from the scope and spirit of the disclosure as disclosed in the accompanying claims.

What is claimed is:

1. A turbocharger structure for a vehicle, the turbocharger structure comprising:
a turbine turned by exhaust gas;
a first scroll is configured to communicate with an exhaust port of an engine block so as to allow the exhaust gas to flow therein, the first scroll surrounding the turbine by extending along a circumferential direction of the turbine and being provided with an opening at an end thereof for discharging exhaust gas to the turbine; and
a second scroll communicating with an exhaust port of the engine block so as to allow exhaust gas to flow therein, the second scroll surrounding the turbine, along with the first scroll by extending along the circumferential direction of the turbine, and being provided with an opening at an end thereof for discharging exhaust gas to the turbine;
wherein the ends of the first scroll and the second scroll having the respective openings are disposed at different locations on a circumference of the turbine.

2. The turbocharger structure of claim 1, wherein the first scroll and the second scroll communicate with different exhaust ports, and alternately receive exhaust gas from the respective exhaust ports.

3. The turbocharger structure of claim 2, wherein an exhaust gas flow distance from the exhaust port communicating with the first scroll to the opening provided at the end of the first scroll is equal to an exhaust gas flow distance from the exhaust port communicating with the second scroll to the opening provided at the end of the second scroll.

4. The turbocharger structure of claim 3, wherein the first scroll communicates with the exhaust port by being connected to a first runner, and the second scroll communicates with the exhaust port by being connected to a second runner, wherein the first runner is longer than the second runner, and wherein the first scroll is shorter than the second scroll.

5. The turbocharger structure of claim 1, wherein each of portions where the first scroll and the second scroll surround the turbine is configured such that a cross-sectional area of exhaust gas flow is reduced as the gas flow approaches an associated opening.
